(19) United States
(12) Patent Application Publication
(10) Pub. No.: US 2026/0192319 A1
(43) Pub. Date: Jul. 9, 2026

(54) COATING APPARATUS, INFORMATION PROCESSING APPARATUS, COATING METHOD, AND RECORDING MEDIUM

(71) Applicant: Daisuke TOKUNAGA, Kanagawa (JP)

(72) Inventor: Daisuke TOKUNAGA, Kanagawa (JP)

(21) Appl. No.: 19/128,219

(22) PCT Filed: Oct. 30, 2023
(86) PCT No.: PCT/IB2023/060893

§ 371 Date: May 8, 2025

(30) Foreign Application Priority Data
Nov. 28, 2022 (JP) 2022-189549

(51) Int. Cl. B05B 12/12; B05B 13/04; B25J 11/00

(52) U.S. Cl. CPC B05B 12/12; B05B 13/04; B25J 11/0075

(57) ABSTRACT

A coating apparatus includes a head including a nozzle and to discharge a liquid from the nozzle to an object; a detector to output information relating to three-dimensional positions of three or more feature points of the object; a movement mechanism to move the head relative to the object; and a controller to control discharge of the liquid by the head and an operation of the movement mechanism based on predetermined shape data of the object and the information relating to the three-dimensional positions of the three or more feature points output from the detector.

### TECHNICAL FIELD

The present disclosure relates to a coating apparatus, an information processing apparatus, a coating method, and a recording medium.

### BACKGROUND ART

A liquid-discharge coating apparatus that coats an object with a liquid discharged from a nozzle is known in the art.

In addition, to perform coating while the distance between a bell for coating attached to a distal end of a robot arm and a vehicle body is kept constant, a technique has been disclosed. The technique uses a distance sensor attached to the distal end of the robot arm to correct scanning path data of offline teaching in accordance with the shape of the vehicle body at a carry-in position (for example, see PTL 1).

### CITATION LIST

### Patent Literature

### [PTL 1]

Japanese Unexamined Patent Application Publication No. 2009-20846

### SUMMARY OF INVENTION

### Technical Problem

In the liquid-discharge coating apparatus, it is desirable to three-dimensionally align the position of an object and the position of a nozzle.

### Solution to Problem

Embodiments of the present disclosure provide a coating apparatus including a head that has a nozzle and that discharges a liquid from the nozzle to an object; a detector that outputs information relating to three-dimensional positions of three or more feature points of the object; a movement mechanism that moves the head relative to the object; and a controller that controls discharge of the liquid by the head and an operation of the movement mechanism based on predetermined shape data of the object and the information relating to the three-dimensional positions of the three or more feature points output from the detector. Embodiments of the present disclosure provide an information processing apparatus including an output unit that, in response to acquisition of predetermined shape data of an object and information relating to three-dimensional positions of three or more feature points of the object output from a detector, outputs information relating to a relative movement path with respect to the object of a head that has a nozzle and that discharges a liquid from the nozzle to the object.

Embodiments of the present disclosure provide a coating method with a coating apparatus. The coating apparatus includes a head including a nozzle, a detector, a movement mechanism, and a controller. The method includes discharging, with the head, a liquid from the nozzle to an object; outputting, with the detector, information relating to three-dimensional positions of three or more feature points of the object; moving, with the movement mechanism, the head relative to the object; and controlling, with the controller, discharge of the liquid by the head and an operation of the movement mechanism based on predetermined shape data of the object and the information relating to the three-dimensional positions of the three or more feature points output from the detector.

Embodiments of the present disclosure provide a recording medium storing a program to cause a coating apparatus to execute a coating method. The coating apparatus includes a head including a nozzle, a detector, a movement mechanism, and a controller. The method includes discharging, with the head, a liquid from the nozzle to an object; outputting, with the detector, information relating to three-dimensional positions of three or more feature points of the object; moving, with the movement mechanism, the head relative to the object; and controlling, with the controller, discharge of the liquid by the head and an operation of the movement mechanism based on predetermined shape data of the object and the information relating to the three-dimensional positions of the three or more feature points output from the detector.

### Advantageous Effects of Invention

With the present disclosure, it is possible to provide a coating apparatus, an information processing apparatus, a coating method, and a recording medium that can three-dimensionally align the position of an object and the position of a nozzle.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a view of an example of a configuration of a coating apparatus according to an embodiment.

FIG. 2 is a block diagram of the example of the configuration of the coating apparatus in FIG. 1.

FIG. 3 is a diagram of an example of a configuration of a supply mechanism included in the coating apparatus in FIG. 1.

FIG. 4 is a perspective view of an example of a configuration of a head included in the coating apparatus in FIG. 1.

FIG. 5 is a cross-sectional view of the head taken along plane P1 in FIG. 4.

FIG. 6 is a block diagram of an example of a functional configuration of a controller according to a first embodiment.

FIG. 7 is a flowchart of an example of a coating operation by the coating apparatus in FIG. 1.

FIG. 8 is a flowchart of an example of detection processing for deviations of the position and inclination of an object by the controller according to the first embodiment.

FIG. 9 is a view illustrating an example of feature points according to an embodiment.

FIG. 10 is an enlarged view of region X in FIG. 9.

FIG. 11 is an enlarged view of region XI in FIG. 9.

FIG. 12 is an enlarged view of region XII in FIG. 9.

FIG. 13 is an enlarged view of region XIII in FIG. 9.

FIG. 14 is a view illustrating an example of a coordinate processing method for feature points according to an embodiment.

FIG. 15 is a view illustrating an example of a correction result of relative movement path information according to an embodiment.

FIG. 16 is a view illustrating an example of relative movement path information.

FIG. 17 is a view illustrating an example of corrected path information.

FIG. 18 is a block diagram of an example of a functional configuration of a controller according to a second embodiment.

FIG. 19 is a flowchart presenting an example of detection processing for an inclination amount of a roof side part with respect to a roof part of an object by the controller according to the second embodiment.

FIG. 20 is a view illustrating an example of a roof molding groove in a rear portion of the roof part.

FIG. 21 is an enlarged view of region XXI in FIG. 20.

FIG. 22 is a cross-sectional view taken along line XXII-XXII in FIG. 21.

FIG. 23 is a view illustrating an example of a roof molding groove in a front portion of the roof part.

FIG. 24 is a view illustrating an example of relative movement path information on the roof side part.

FIG. 25 is a view illustrating an example of corrected path information on the roof side part. The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Hereinafter, a coating apparatus, an information processing apparatus, a coating method, and a recording medium according to embodiments of the present disclosure will be described in detail with reference to the drawings. However, the embodiments described below are illustrative of a coating apparatus, an information processing apparatus, a coating method, and a recording medium for embodying the technical idea of the present disclosure, and the present disclosure is not limited to the embodiments described below. The dimensions, materials, shapes, relative arrangements, and so forth, of components described in the embodiments are not intended to limit the scope of the present disclosure thereto, and are intended to be examples unless otherwise specifically indicated. The sizes, positional relationship, and so forth, of members illustrated in the drawings may be exaggerated for clarity of description. In the following description, identical names and reference signs represent identical or equivalent members, and detailed description thereof is appropriately omitted.

### Example of Configuration of Coating Apparatus 100

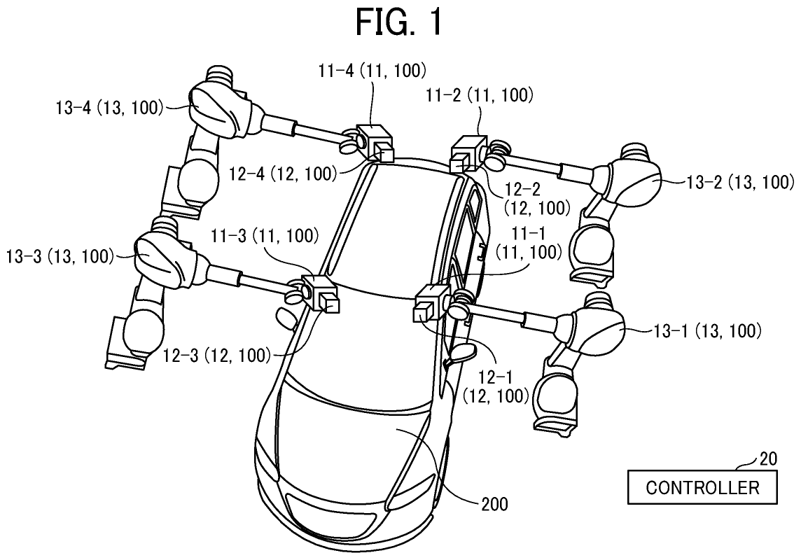

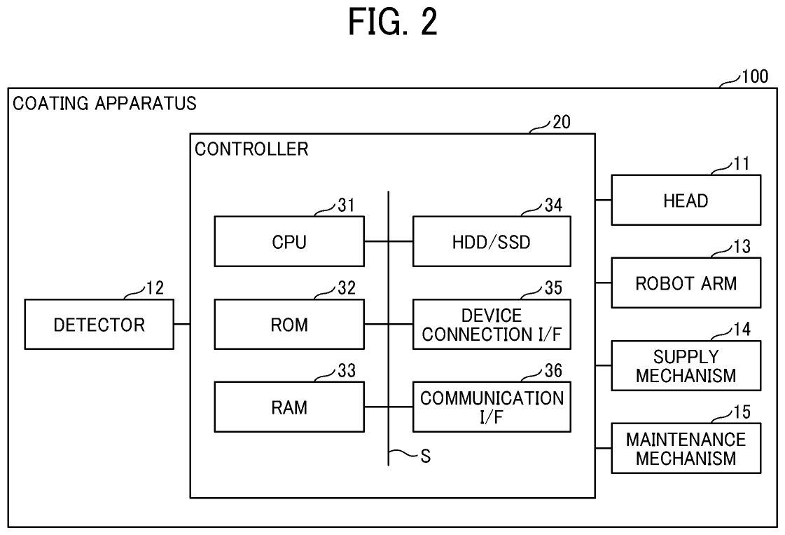

A configuration of a coating apparatus 100 according to an embodiment is described referring to FIGS. 1 and 2.

FIG. 1 is a view illustrating an example of the configuration of the coating apparatus 100.

FIG. 2 is a block diagram illustrating the example of the configuration of the coating apparatus 100.

As illustrated in FIG. 1, the coating apparatus 100 applies a liquid discharged by a liquid discharge method to an object 200. The liquid applied to the object 200 is dried and then sticks to the object 200.

The liquid discharge method by the coating apparatus 100 is, for example, a continuous discharge method. Examples of the continuous discharge method include a valve method of controlling the operation of a valve body to open and close a nozzle to control discharge; and a continuous method of electrically charging ink particles continuously discharged from a nozzle, bending the charged ink particles using a deflection electrode, and spraying the bent ink particles to a printing surface.

Examples of the object 200 include bodies of a vehicle, an aircraft, a ship, and so forth. Examples of the vehicle include an automobile, a truck, a train, and so forth. In the description, a case where the object 200 is a vehicle is described as an example.

An application surface, which is a surface of an object 200 to which a liquid is applied, has impermeability. The impermeability refers to a property that the liquid applied to the application surface does not permeate the inside. The coating apparatus 100 can coat the application surface of the object 200 having impermeability by applying the liquid to the object 200. However, the application surface of the object 200 is not limited to the surface having impermeability, and may be a surface having permeability. The application surface is not limited to a flat surface, and may be a curved surface.

As illustrated in FIGS. 1 and 2, the coating apparatus 100 includes four heads 11, four detectors 12, four robot arms 13, a supply mechanism 14, a maintenance mechanism 15, and a controller 20. The coating apparatus 100 drives the robot arms 13 that hold the four heads 11 under the control of the controller 20 based on predetermined shape data of an object 200 and information relating to three-dimensional positions of three or more feature points output from each of the four detectors 12. The coating apparatus 100 changes relative positions and relative inclinations of the four heads 11 and the object 200 by the driving of the four robot arms 13, and discharges a liquid from each of the four heads 11 to the object 200. The coating apparatus 100 applies the liquid discharged from the four heads 11 to the object 200 to coat the object 200 with the liquid.

The four heads 11 include a head 11-1, a head 11-2, a head 11-3, and a head 11-4. The four heads 11 may have the same configuration or different configurations. In the description, it is assumed that the four heads 11 have the same configuration. The number of heads 11 included in the coating apparatus 100 is not limited to four, and can be appropriately changed in accordance with the size, shape, and so forth, of the object 200.

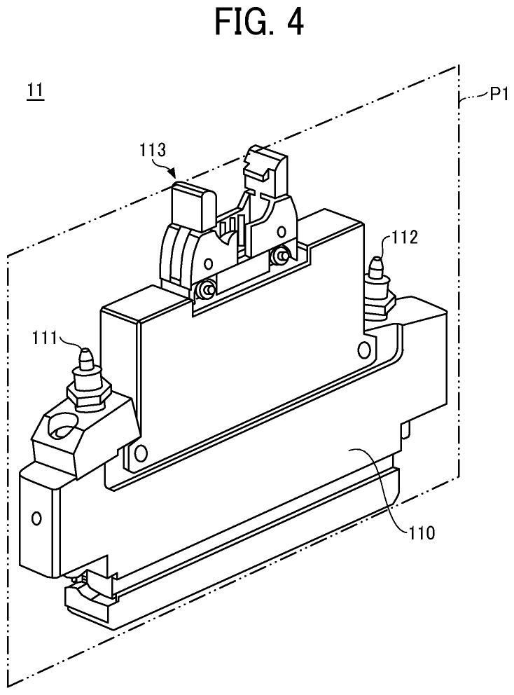

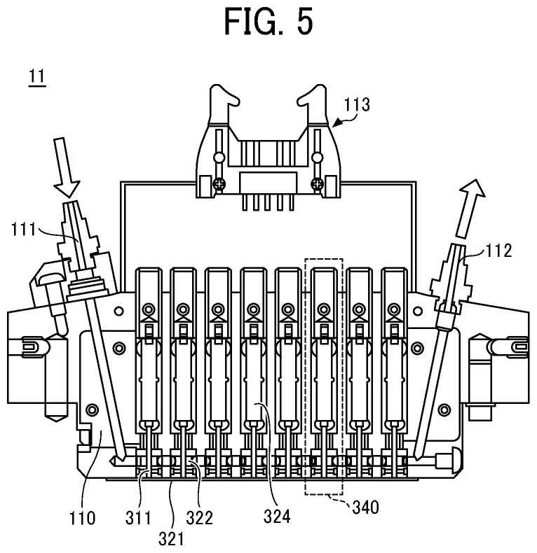

Each of the four heads 11 discharges a liquid from a nozzle to the object 200. For example, the head 11 includes a nozzle surface having a plurality of nozzles that discharge a liquid, and is disposed so that the nozzle surface faces the application surface of the object 200. Each of the four heads 11 applies the liquid discharged from each of the plurality of nozzles to the object 200. The configuration of the head 11 will be described later in detail referring also to FIGS. 4 and 5.

The four heads 11 may discharge the liquid to mutually different regions of the object 200. The liquid discharged from the four heads 11 may be discharged to regions partly overlapping one another. Since the four heads 11 discharge the liquid to the mutually different regions of the object 200, coating can be performed in a short time even when the size of the object 200 is large.

The four detectors 12 include a detector 12-1, a detector 12-2, a detector 12-3, and a detector 12-4. The four detectors 12 may have the same configuration or different configurations. In the description, it is assumed that the four detectors 12 have the same configuration. The number of the detectors 12 included in the coating apparatus 100 is not limited to four, and can be appropriately changed in accordance with the number of the heads 11 or the like.

Each of the four detectors 12 outputs feature point information that is information relating to three-dimensional positions of three or more feature points of the object 200. Each of the four detectors 12 includes, for example, a stereo camera. The stereo camera includes a plurality of cameras and acquires a distance image of the object 200 by triangulation based on a parallax between images captured by the plurality of cameras. The stereo camera outputs the distance image as feature point information to the controller 20. The distance image is an image in which each of a plurality of pixels included in the image includes distance information. Since the detector 12 includes the stereo camera, the coating apparatus 100 can acquire feature point information on the object 200 with a simple configuration. However, the detector 12 is not limited to the configuration including the stereo camera, and a configuration other than the stereo camera may be used as long as the detector 12 can acquire and output feature point information on the object 200.

The four detectors 12 may acquire items of feature point information from mutually different regions of the object 200 and output the items of feature point information. For example, the stereo cameras included in the four detectors 12 can acquire distance images of mutually different regions of the object 200, and output the distance images as the items of feature point information. The items of feature point information output from the four detectors 12 may partially overlap one another. Since the four detectors 12 acquire the items of feature point information from the mutually different regions of the object 200, the items of feature point information can be acquired in a short time even when the size of the object 200 is large.

The four robot arms 13 include a robot arm 13-1, a robot arm 13-2, a robot arm 13-3, and a robot arm 13-4. The four robot arms 13 may have the same configuration or different configurations. In the description, it is assumed that the four robot arms 13 have the same configuration. The number of the robot arms 13 included in the coating apparatus 100 is not limited to four, and can be appropriately changed in accordance with the number of the heads 11 or the like.

Each of the four robot arms 13 is an example of a movement mechanism that moves the head 11 relative to the object 200. Each of the four robot arms 13 is disposed in the vicinity of the object 200. In this case, the four robot arms 13 are disposed around the object 200, each of which holds the head 11 and the detector 12, and each of which moves each of the head 11 and the detector 12 relative to the object 200. The movement mechanism is not limited to the robot arm 13 and may be a combination of a plurality of linear motion stages or the like as long as the head 11 can be moved relative to the object 200.

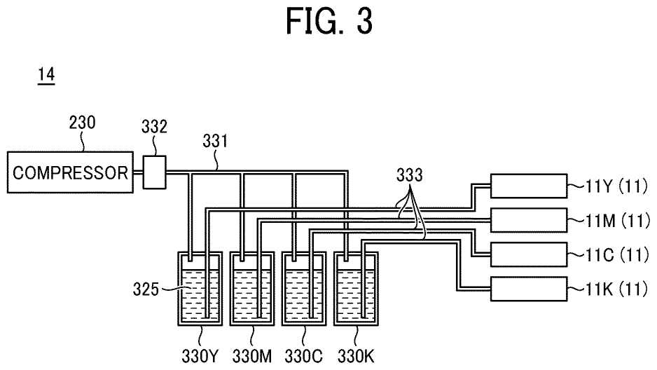

Referring to FIG. 2, the supply mechanism 14 supplies the liquid to each of the four heads 11. The configuration of the supply mechanism 14 will be described later in detail referring also to FIG. 3.

The maintenance mechanism 15 maintains the discharge state of the liquid by each of the four heads 11. The maintenance mechanism 15 includes, for example, a wiper that wipes the nozzle surface of each of the four heads 11, and a suction pump that sucks the liquid from the inside of each of the four heads 11. The maintenance mechanism 15 uses the wiper, the suction pump, and so forth to remove a viscous liquid or a foreign substance adhering to the nozzle surface or a viscous liquid, a foreign substance, or the like present in the head 11. The maintenance mechanism 15 can reduce abnormal discharge such as non-discharge, curved discharge, or a variation in discharge speed in each of the four heads 11 by removing a viscous liquid, a foreign substance, or the like, and can maintain the discharge state of each of the four heads 11 in a normal state.

Referring to FIGS. 1 and 2, the controller 20 controls discharge of the liquid by the head 11 and an operation of the robot arm 13 based on the predetermined shape data of the object 200 and the feature point information output from the detector 12.

For example, the controller 20 causes the head 11 to move relative to the object 200 based on information that relates to the relative positions and relative inclinations of the object 200 and the nozzle included in the head 11 and that is obtained from the predetermined shape data of the object 200 and the feature point information output from the detector 12. In this case, the controller 20 controls the operations of the four robot arms 13 to move the four heads 11 and the four detectors 12 held by the four robot arms 13 relative to the object 200.

The controller 20 includes, for example, a processor or an electric circuit mounted on an electric substrate. The controller 20 is connected to each of the four heads 11, the four detectors 12, and the four robot arms 13 in a communicable manner by wire or wirelessly. The controller 20 can receive detection signals from the four detectors 12 and transmit control signals to the four heads 11 and the four robot arms 13. The electric substrate with the controller 20 mounted may be disposed at any position, and the electric substrate may be disposed at a position remote from the head 11 or the like.

As illustrated in FIG. 2, the controller 20 includes a central processing unit (CPU) 31, a read only memory (ROM) 32, a random access memory (RAM) 33, a hard disk drive (HDD)/solid state drive (SSD) 34, a device connection interface (I/F) 35, and a communication interface (I/F) 36. These components are electrically connected to one another via a system bus S.

The CPU 31 uses the RAM 33 as a work area, and executes processing prescribed in a program stored in the ROM 32 to control the entire operation of the controller 20.

The ROM 32 is a non-volatile memory that stores a program for executing control such as a recording operation on the CPU 31, and other fixed data.

The RAM 33 is a volatile memory that temporarily stores various data used for, for example, the discharge of the liquid by the head 11 and the driving of the robot arm 13, and the detection result by the detector 12.

The HDD/SSD 34 is a volatile memory that temporarily stores shape data of the object 200, image data of a pattern, characters, and so forth to be drawn on the object 200, and so forth.

The device connection I/F 35 is an interface for connection to each of the head 11, the detector 12, the robot arm 13, the supply mechanism 14, and the maintenance mechanism 15 in a communicable manner.

The communication I/F 36 is an interface that connects an external device such as a host personal computer (PC) to the controller 20 in a communicable manner.

The coating apparatus 100 may further include a display section (display) that displays a setting screen or the like for conditions of application of the liquid by the coating apparatus 100, and an operation section that is an operation input device, such as a touch panel, a keyboard, or a mouse, that accepts operations of the coating apparatus 100.

### Example of Configuration of Supply Mechanism 14

FIG. 3 is a view illustrating an example of a configuration of the supply mechanism 14.

The four heads 11 include a head 11Y that discharges a liquid of yellow (Y), a head 11M that discharges a liquid of magenta (M), a head 11C that discharges a liquid of cyan (C), and a head 11K that discharges a liquid of black (K).

The head 11 may further include heads that discharge other liquids, such as a head that discharges an overcoat liquid and a head that discharges a primer liquid or a white liquid, in addition to the heads that discharge the liquids of the respective colors. The supply mechanism 14 can supply the liquids of the respective colors to the heads 11.

The supply mechanism 14 includes liquid tanks 330 serving as sealed containers that house liquids 325 of the respective colors to be discharged from the heads 11. The liquid tanks 330 and injection ports (supply ports) of the heads 11 are coupled to one another via tubes 333 in a manner that the liquids can flow therethrough.

The liquid tanks 330 are coupled to a compressor 230 via a pipe 331 including an air regulator 332. The compressor 230 supplies pressurized air. Thus, the pressurized liquids 325 of the respective colors are supplied to the injection ports of the heads 11. The coating apparatus 100 discharges the liquids 325 from the nozzles of the heads 11.

### Example of Configuration of Head 11

FIGS. 4 and 5 are views illustrating an example of a configuration of the head 11. FIG. 4 is a perspective view, and FIG. 5 is a cross-sectional view of the head 11 taken along plane P1 in FIG. 4.

As illustrated in FIGS. 4 and 5, the head 11 includes a plurality of discharge modules 340 arranged in one row or a plurality of rows in a housing 110.

The head 11 includes a supply port 111 and a recovery port 112. The supply port 111 supplies a pressurized liquid from the outside to the discharge modules 340. The recovery port 112 ejects a non-discharged liquid to the outside. The housing 110 also includes a connector 113.

As illustrated in FIG. 5, each of the discharge modules 340 includes a nozzle plate 321 provided with a nozzle 311 that discharges a liquid, a flow path 322 that is in communication with the nozzle 311 and that supplies a pressurized liquid, and a piezoelectric element 324 that drives a needle-shaped valve body that opens and closes the nozzle 311.

The nozzle plate 321 is joined to the housing 110. The flow path 322 is a flow path common to the plurality of discharge modules 340 provided in the housing 110. The coating apparatus 100 supplies the pressurized liquid from the supply port 111 through the flow path 322, and ejects the liquid from the recovery port 112. In a period in which the liquid is discharged to the object 200, the ejection of the liquid from the recovery port 112 may be temporarily stopped to avoid a decrease in discharge efficiency of the liquid from the nozzle 311.

### Example of Functional Configuration of Controller 20

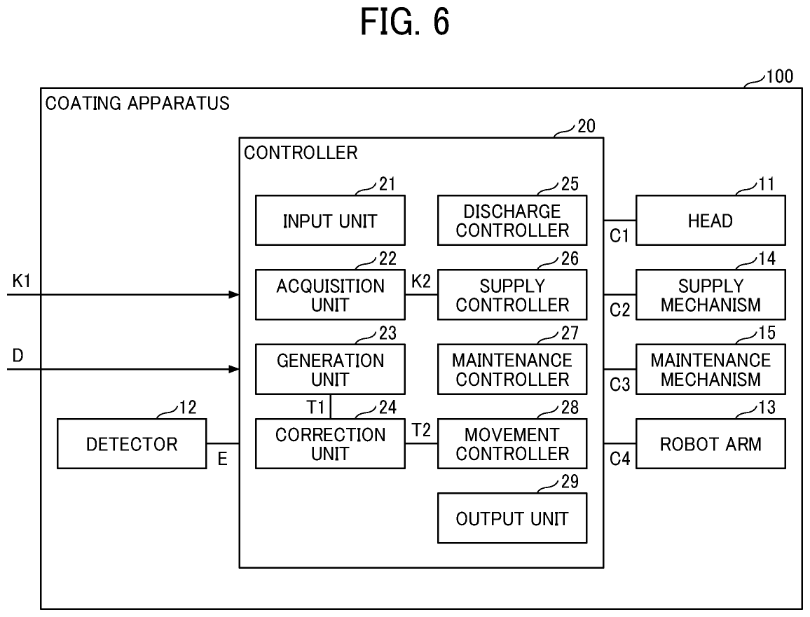

FIG. 6 is a block diagram illustrating an example of a functional configuration of the controller 20. The controller 20 includes an input unit 21, an acquisition unit 22, a generation unit 23, a correction unit 24, a discharge controller 25, a supply controller 26, a maintenance controller 27, a movement controller 28, and an output unit 29.

The functions of the input unit 21 and the output unit 29 are implemented by, for example, the device connection I/F 35 and the communication I/F 36 in FIG. 2.

The functions of the acquisition unit 22, the generation unit 23, the correction unit 24, the discharge controller 25, the supply controller 26, the maintenance controller 27, and the movement controller 28 are implemented such that the CPU 31 loads a program stored in the ROM 32 into the RAM 33 and executes processing prescribed in the program.

In one example, a component such as the head 11 other than the controller 20 may have at least part of the functions of the controller 20. In one example, at least part of the functions of the controller 20 may be implemented by distributed processing between the controller 20 and a component other than the controller 20.

The input unit 21 controls communication with an external device to receive shape data D of an object 200 and object information K1 that is information indicative of the object 200 from the external device. The input unit 21 controls communication with the detector 12 to receive feature point information E from the detector 12.

The acquisition unit 22 acquires coating color information K2 that is information relating to the color of a liquid with which the object 200 is coated based on the object information K1 received from the external device via the input unit 21. For example, the acquisition unit 22 acquires the coating color information K2 with reference to a table indicative of the correspondence relationship between the object information K1 and the coating color information K2 created in advance and stored in the HDD/SSD 34 or the like in FIG. 2. The acquisition unit 22 outputs the acquired coating color information K2 to the supply controller 26.

The generation unit 23 generates relative movement path information T1 that is information relating to a relative movement path along which the robot arm 13 moves the head 11 relative to the object 200 based on the shape data D of the object 200 received from the external device via the input unit 21. The shape data D is, for example, computer aided design (CAD) data of the object 200 including information on the dimensions and arrangement of the object 200. The generation unit 23 outputs the generated relative movement path information T1 to the correction unit 24.

The relative movement path represents a path along which the head 11 passes over the object 200 while changing the relative position of the head 11 with respect to the object 200. The head 11 may change the relative inclination with respect to the object 200 in accordance with the shape of the object 200 at each relative position with respect to the object 200. When the head 11 changes the relative inclination with respect to the object 200, the relative movement path represents a path along which the head 11 passes over the object 200 while changing the relative position and relative inclination with respect to the object 200.

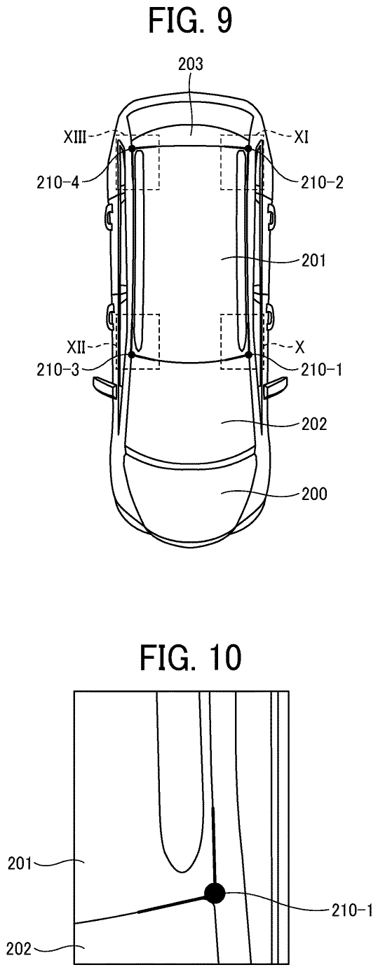

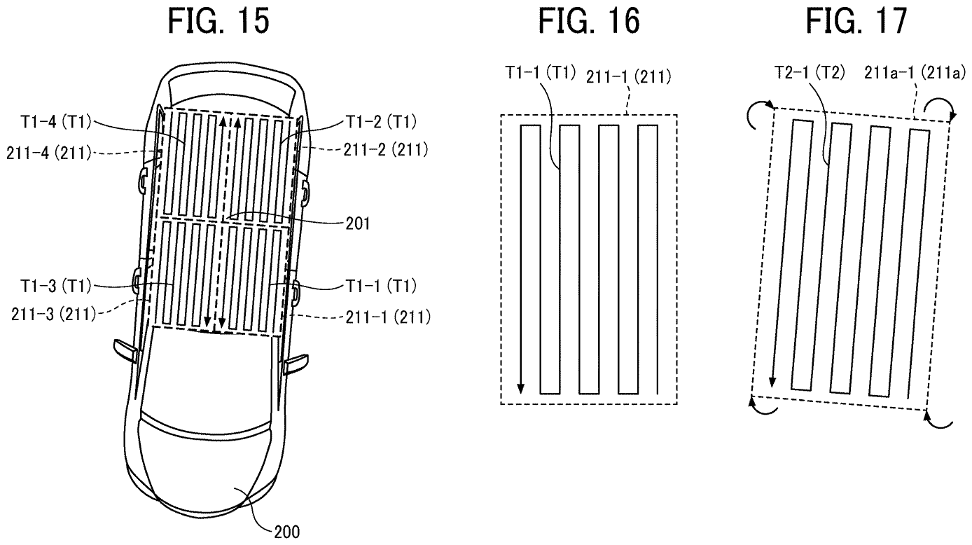

The correction unit 24 corrects the relative movement path information T1 generated by the generation unit 23 based on the feature point information E received from each of the plurality of detectors 12 via the input unit 21. The correction unit 24 outputs corrected path information T2 that is information relating to a relative movement path after the correction to the movement controller 28. The feature point information E will be described later in detail referring also to FIGS. 9 to 14. The corrected path information T2 will be described later in detail referring also to FIGS. 15 to 17.

For example, when an object 200 is conveyed to a position at which the coating apparatus 100 performs coating on the object 200 and coating is performed in a stop state, the position and inclination of the conveyed object 200 may vary for each conveyed object 200 in accordance with a conveyance error or the like of a conveyance device such as a conveyor. When the position and inclination of the object 200 vary, and when the head 11 is moved relative to the object 200 based on the relative movement path information T1, the relative positions and relative inclinations of the nozzle included in the head 11 and the object 200 may be deviated with respect to the shape data D, and coating omission or coating unevenness may occur. The coating omission refers to that an area to be coated on the object 200 is not coated. The coating unevenness refers to that the thickness of a coating film becomes non-uniform, or the hue, density, or the like of the coating color becomes non-uniform.

The correction unit 24 detects three-dimensional deviations of the position and inclination of the conveyed object 200 with respect to the shape data D based on the feature point information E. The three-dimensional deviations of the position and inclination of the object 200 with respect to the shape data D correspond to information relating to the position and inclination of the object 200.

The correction unit 24 corrects the relative movement path information T1 in accordance with the detection result of the three-dimensional deviations of the position and inclination of the object 200 with respect to the shape data D to acquire corrected path information T2. The correction unit 24 outputs the acquired corrected path information T2 to the movement controller 28. The coating apparatus 100 moves the head 11 relative to the object 200 in accordance with the corrected path information T2. Thus, the coating apparatus 100 can three-dimensionally align the position of the object 200 and the position of the nozzle of the head 11 and perform coating.

The discharge controller 25 outputs a discharge control signal C1 via the output unit 29 to control the discharge of the liquid from the plurality of heads 11. The discharge controller 25 can control, for example, the selection of a nozzle that discharges the liquid from among the plurality of nozzles included in each of the plurality of heads 11, the timing of discharging the liquid from the nozzle, the amount of the liquid to be discharged from the nozzle, and the discharge frequency.

The discharge controller 25 can control the selection of the nozzle that discharges the liquid, the timing of discharging the liquid from the nozzle, and so forth, based on the corrected path information T2.

The supply controller 26 outputs a supply control signal C2 via the output unit 29 to control the supply of the liquid from the supply mechanism 14 to the plurality of heads 11. The supply controller 26 can control, for example, the selection of the color of a liquid to be supplied to the plurality of heads 11, the timing of supply, and the amount of supply.

The maintenance controller 27 outputs a maintenance control signal C3 via the output unit 29 to maintain the discharge state of the liquid from the plurality of heads 11 through the maintenance mechanism 15. The maintenance controller 27 can control, for example, the selection of a head to be maintained from among the plurality of heads 11, and the timing of the maintenance operation.

The movement controller 28 outputs a movement control signal C4 via the output unit 29 based on the corrected path information T2 to control the relative movement of each of the plurality of heads 11 by the plurality of robot arms 13 with respect to the object 200. The movement controller 28 controls, for example, the movement direction, movement speed, and movement acceleration of the head 11 by the robot arm 13. In this case, the movement controller 28 performs control to change the relative position and relative inclination of each of the plurality of heads 11 with respect to the object 200.

The output unit 29 controls communication with the head 11 to output the discharge control signal C1 to the head 11. The output unit 29 also controls communication with the robot arm 13 to output the movement control signal C4 to the robot arm 13. The output unit 29 further controls communication with the supply mechanism 14 to output the supply control signal C2 to the supply mechanism 14. The output unit 29 further controls communication with the maintenance mechanism 15 to output the maintenance control signal C3 to the maintenance mechanism 15.

The above-described output unit 29 corresponds to an output unit that, in response to acquisition of predetermined shape data D of the object 200 and information relating to three-dimensional positions of three or more feature points of the object 200 output from the detector 12, outputs information relating to a relative movement path of the head 11 with respect to the object 200. The controller 20 including the output unit 29 corresponds to an information processing apparatus according to the embodiment.

### Example of Operation of Coating Apparatus 100

### Example of Coating Operation

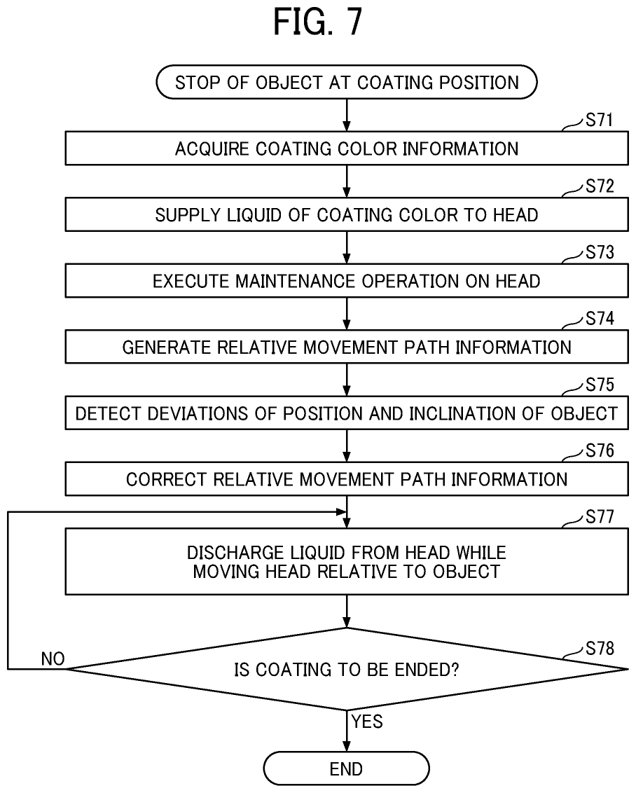

FIG. 7 is a flowchart presenting an example of a coating operation by the coating apparatus 100. The coating apparatus 100 starts the operation illustrated in FIG. 7 in response to that an object 200 has stopped at the coating position by the coating apparatus 100. Whether the object 200 has stopped at the coating position can be detected based on a signal from the conveyor or the like that conveys the object 200.

First, in step S71, the acquisition unit 22 of the coating apparatus 100 acquires coating color information K2 that is information relating to the color of a liquid to be applied on the object 200 based on object information K1 received from an external device via the input unit 21. The acquisition unit 22 outputs the acquired coating color information K2 to the supply controller 26.

Then, in step S72, the supply controller 26 of the coating apparatus 100 controls the operation of the supply mechanism 14 to supply the liquid of the color corresponding to the coating color information K2 to each of the four heads 11. In one example, when the plurality of heads discharge respectively different colors of liquids, the coating apparatus 100 may supply the liquid to the head that discharges the liquid of the color corresponding to the coating color information K2. In one example, when the coating apparatus 100 performs coating with a plurality of colors, the coating apparatus 100 may supply liquids of different colors to each of the four heads 11.

Then, in step S73, the maintenance controller 27 of the coating apparatus 100 controls the operation of the maintenance mechanism 15 to execute the maintenance operation on the four heads 11 that discharge the liquid of the color corresponding to the coating color information K2. In one example, when the plurality of heads discharge respectively different colors of liquids, the coating apparatus 100 may execute the maintenance operation on the head that discharges the liquid of the color corresponding to the coating color information K2.

Then, in step S74, the generation unit 23 of the coating apparatus 100 generates relative movement path information T1 based on shape data D of the object 200 received from the external device via the input unit 21. The generation unit 23 outputs the generated relative movement path information T1 to the correction unit 24.

Then, in step S75, the correction unit 24 of the coating apparatus 100 detects three-dimensional deviations of the position and inclination of the conveyed object 200 with respect to the shape data D based on feature point information E received from each of the plurality of detectors 12 via the input unit 21.

Then, in step S76, the correction unit 24 of the coating apparatus 100 corrects the relative movement path information T1 in accordance with the detection result of the three-dimensional deviations of the position and inclination of the object 200 with respect to the shape data D to acquire corrected path information T2. The correction unit 24 outputs the acquired corrected path information T2 to the movement controller 28.

Then, in step S77, the movement controller 28 of the coating apparatus 100 controls the operations of the four robot arms 13 to move the four heads 11 while changing the relative position and relative inclination of each of the plurality of heads 11 with respect to the object 200. At the coating apparatus 100, the discharge controller 25 controls the relative movement of the heads 11 and the discharge of the liquid by each of the four heads 11 to perform coating on the object 200. The coating apparatus 100 may relatively move the head 11 over an area of the object 200 not to be coated without causing the head 11 to discharge the liquid on the area. The coating apparatus 100 may perform coating while appropriately changing the relative movement speed of the head 11 by the robot arm 13, the discharge frequency by the head 11, or the like.

Then, in step S78, the controller 20 of the coating apparatus 100 determines whether coating is to be ended. For example, the controller 20 can determine whether coating is to be ended by accepting an operation input of a coating end instruction via the operation section, or by determining whether a predetermined coating range of the object 200 has been coated.

Then, in step S78, when it is determined that coating is not to be ended (NO in step S78), the coating apparatus 100 performs the operation in step S77 and later again. In contrast, in step S78, when it is determined that coating is to be ended (YES in step S78), the coating apparatus 100 ends the operation.

As described above, the coating apparatus 100 can perform coating on the object 200. After coating on one object 200 is ended, when the next object 200 has been conveyed to the coating position by the conveyor or the like and has been stopped, the coating apparatus 100 performs the operations in step S71 and later to perform coating on the next object 200.

### Example of Detection Processing for Deviations of Position and Inclination of Object 200

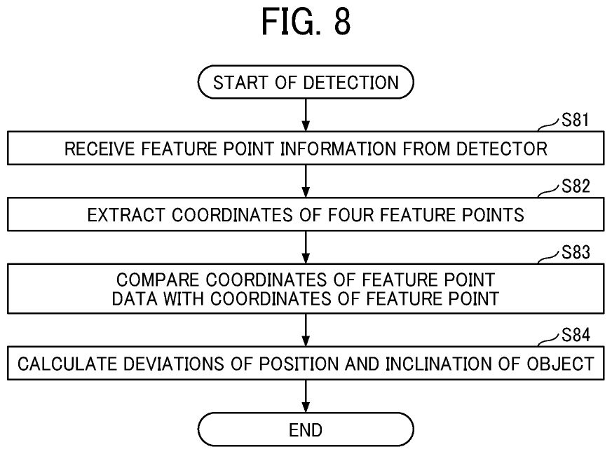

FIG. 8 is a flowchart presenting an example of detection processing for deviations of the position and inclination of an object 200 with respect to shape data D by the correction unit 24, the detection processing being included in the coating operation by the coating apparatus 100 presented in FIG. 7. The correction unit 24 starts the processing in FIG. 8 at the timing of performing the operation in step S75 in FIG. 7.

First, in step S81, the correction unit 24 receives feature point information E output from each of the four detectors 12 via the input unit 21.

Then, in step S82, the correction unit 24 extracts four sets of feature point coordinates based on four items of feature point information E. For example, the feature point information E is a distance image from the stereo camera in one detector 12. The feature point coordinates are coordinates of a feature point extracted in the distance image. The correction unit 24 receives a distance image from each of the four detectors 12, and extracts feature point coordinates from each of the four distance images.

Then, in step S83, the correction unit 24 compares the coordinates of feature point data that is a point corresponding to a feature point in the shape data D with the coordinates of the feature point.

Then, in step S84, the correction unit 24 calculates three-dimensional deviations of the position and inclination of the object 200 with respect to the shape data D in accordance with the comparison result in step S83.

As described above, the correction unit 24 can detect the three-dimensional deviations of the position and inclination of the object 200 with respect to the shape data D.

### Example of Feature Point

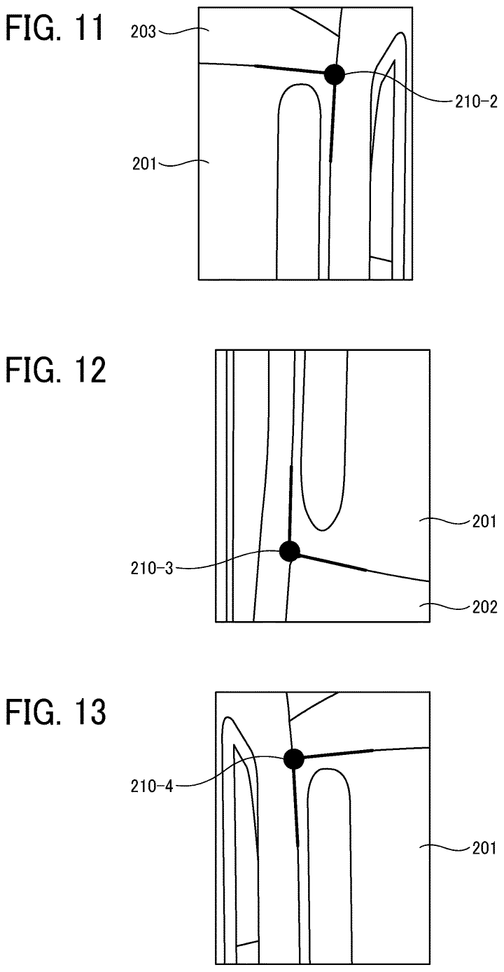

Referring to FIGS. 9 to 13, feature points used by the coating apparatus 100 are described. FIG. 9 is a view illustrating an example of feature points according to an embodiment. FIG. 10 is an enlarged view of region X in FIG. 9. FIG. 11 is an enlarged view of region XI in FIG. 9. FIG. 12 is an enlarged view of region XII in FIG. 9. FIG. 13 is an enlarged view of region XIII in FIG. 9.

FIG. 9 illustrates a roof part 201 and its periphery of an object 200 in a view from above. A feature point 210-1 is a corner on the boundary between the roof part 201 and a front window 202. A feature point 210-2 is a corner on the boundary between the roof part 201 and a rear panel 203. A feature point 210-3 is another corner on the boundary between the roof part 201 and the front window 202. A feature point 210-4 is another corner on the boundary between the roof part 201 and the rear panel 203.

The detector 12-1 illustrated in FIG. 1 acquires and outputs a distance image around the feature point 210-1 including the feature point 210-1 as feature point information E. The detector 12-2 illustrated in FIG. 1 acquires and outputs a distance image around the feature point 210-2 including the feature point 210-2 as feature point information E. The detector 12-3 illustrated in FIG. 1 acquires and outputs a distance image around the feature point 210-3 including the feature point 210-3 as feature point information E. The detector 12-4 illustrated in FIG. 1 acquires and outputs a distance image around the feature point 210-4 including the feature point 210-4 as feature point information E.

Since the four detectors 12 are separate and independent from one another, when the relationship among the three-dimensional positions of the four detectors 12 is not clear, the three-dimensional coordinate systems of the distance images acquired by the four detectors 12 are independent from one another and do not correspond to one another. In this case, it is difficult to cooperatively drive the four robot arms that hold the four detectors 12 and the four heads 11 to perform coating based on the outputs of the four detectors 12.

In the present embodiment, the three-dimensional positions of the four robot arms 13 that hold the four detectors 12 and the four heads 11 are measured in advance to clarify the relationship among the three-dimensional positions of the four robot arms 13. Then, the three-dimensional coordinate systems of the four robot arms 13 are associated with one another to express the three-dimensional positions of the four robot arms 13 in one three-dimensional coordinate system. Thus, the items of feature point information E output from the four detectors 12 held by the four robot arms 13 can be expressed in one three-dimensional coordinate system.

### Example of Coordinate Processing Method for Feature Points

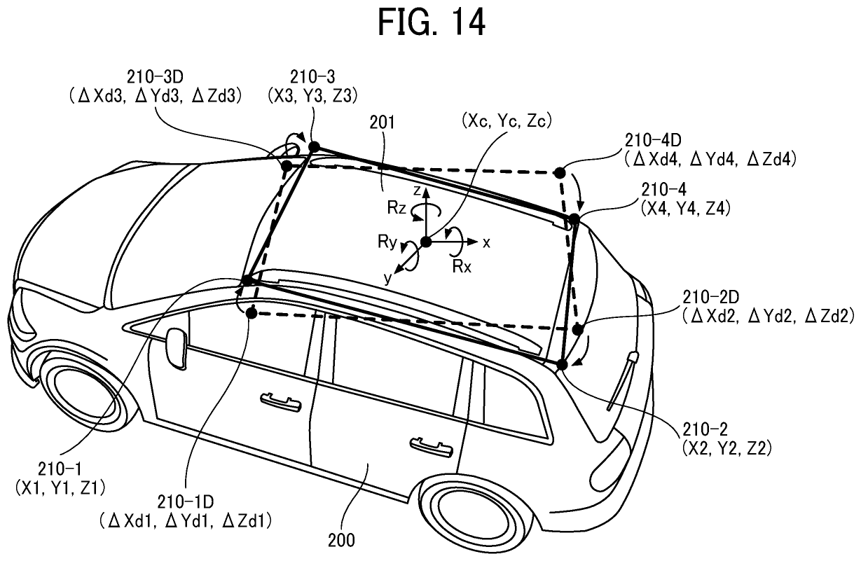

FIG. 14 is a view illustrating an example of a coordinate processing method for feature points according to an embodiment. Referring to FIG. 14, coordinates (X1, Y1, Z1) are coordinates representing a three-dimensional position of a feature point 210-1. Coordinates (X2, Y2, Z2) are coordinates representing a three-dimensional position of a feature point 210-2. Coordinates (X3, Y3, Z3) are coordinates representing a three-dimensional position of a feature point 210-3. Coordinates (X4, Y4, Z4) are coordinates representing a three-dimensional position of a feature point 210-4.

Feature point data 210-1D is data corresponding to the feature point 210-1 in shape data D. Feature point data 210-2D is data corresponding to the feature point 210-2 in the shape data D. Feature point data 210-3D is data corresponding to the feature point 210-3 in the shape data D. Feature point data 210-4D is data corresponding to the feature point 210-4 in the shape data D.

Coordinates (ΔXd1, ΔYd1, ΔZd1) are coordinates representing a three-dimensional position of the feature point data 210-1D. Coordinates (ΔXd2, ΔYd2, ΔZd2) are coordinates representing a three-dimensional position of the feature point data 210-2D. Coordinates (ΔXd3, ΔYd3, ΔZd3) are coordinates representing a three-dimensional position of the feature point data 210-3D. Coordinates (ΔXd4, ΔYd4, ΔZd4) are coordinates representing a three-dimensional position of the feature point data 210-4D.

The correction unit 24 illustrated in FIG. 6 calculates a positional deviation (AX, ΔY, ΔZ) and an inclination amount (Rx, Ry, Rx) through comparison between the coordinates (X1, Y1, Z1) and the coordinates (ΔXd1, ΔYd1, ΔZd1), comparison between the coordinates (X2, Y2, Z2) and the coordinates (ΔXd2, ΔYd2, ΔZd2), comparison between the coordinates (X3, Y3, Z3) and the coordinates (ΔXd3, ΔYd3, ΔZd3), and comparison between the coordinates (X4, Y4, Z4) and the coordinates (ΔXd4, ΔYd4, ΔZd4). Reference sign AX represents a positional deviation in the X-axis direction, reference sign ΔY represents a positional deviation in the Y-axis direction, and reference sign ΔZ represents a positional deviation in the Z-axis direction. Reference sign Rx denotes an inclination amount around the X-axis, reference sign Ry denotes an inclination amount around the Y-axis, and reference sign Rz denotes an inclination amount around the Z-axis. Coordinates (Xc, Yc, Zc) represent the center of the roof part 201.

The correction unit 24 corrects the relative movement path information T1 generated by the generation unit 23 illustrated in FIG. 6 by three-dimensional coordinate conversion processing using the positional deviation (ΔX, ΔY, ΔZ) and the inclination amount (Rx, Ry, Rz) to acquire corrected path information T2.

### Example of Correction Result of Relative Movement Path Information T1

A correction result of relative movement path information T1 is described referring to FIGS. 15 to 17. FIG. 15 is a view illustrating an example of a correction result of relative movement path information T1. FIG. 16 is a view illustrating an example of relative movement path information T1. FIG. 17 is a view illustrating an example of corrected path information T2.

FIG. 15 illustrates a coating range 211 and relative movement path information T1 of the head 11.

The coating range 211 is a range in which each of the four robot arms 13 illustrated in FIG. 1 moves the head 11 relative to an object 200 to perform coating. The four heads 11 have respectively different coating ranges 211 and respectively different items of relative movement path information T1.

A coating range 211-1 indicates a range in which the head 11-1 is moved by the robot arm 13-1 relative to the object 200 to perform coating. Relative movement path information T1-1 indicates a path along which the head 11-1 moves relative to the object 200.

A coating range 211-2 indicates a range in which the head 11-2 is moved by the robot arm 13-2 relative to the object 200 to perform coating. Relative movement path information T1-2 indicates a path along which the head 11-2 moves relative to the object 200.

A coating range 211-3 indicates a range in which the head 11-3 is moved by the robot arm 13-3 relative to the object 200 to perform coating. Relative movement path information T1-3 indicates a path along which the head 11-3 moves relative to the object 200.

A coating range 211-4 indicates a range in which the head 11-4 is moved by the robot arm 13-4 relative to the object 200 to perform coating. Relative movement path information T1-4 indicates a path along which the head 11-4 moves relative to the object 200.

FIG. 16 illustrates the coating range 211-1 by the head 11-1 and the relative movement path information T1-1 among the four coating ranges 211 and the four items of relative movement path information T1. FIG. 17 illustrates a coating range 211a-1 and corrected path information T2-1 corrected through the three-dimensional coordinate conversion processing by the correction unit 24 in FIG. 6. Even when the coating range 211 and the relative movement path information T1 are subjected to the three-dimensional conversion processing, the deviations of the position and inclination of the head 11 with respect to the shape data D are corrected without a change in the movement distance in the longitudinal direction or the line feed width in the transverse direction. By performing the processing in this way, the processing by the correction unit 24 can be simplified.

Based on the corrected path information T2, the coating apparatus 100 moves the head 11 relative to the object 200 and discharges the liquid to perform coating in a state in which the position of the object 200 and the position of the nozzle are three-dimensionally aligned. In other words, in the present embodiment, it is possible to provide the coating apparatus 100 that can three-dimensionally align the position of the object 200 and the position of the nozzle. Thus, even when the position and inclination of the object 200 conveyed to the coating position vary depending on the object 200, coating can be performed on the object 200 with reduced coating omission or coating unevenness. While the example of using the four items of feature point information E output from the four detectors 12 has been described in the present embodiment, the above-described advantageous effect can be obtained as long as the number of items of feature point information E is three or more.

In the present embodiment, the head 11 discharges a liquid from each of the plurality of nozzles.

Thus, a plurality of regions on the object 200 can be coated simultaneously, and hence the coating time can be reduced as compared to a case where a liquid is discharged from one nozzle to perform coating.

In the present embodiment, the movement mechanism includes the robot arm 13 that holds the head 11 and the detector 12 and that moves each of the head 11 and the detector 12 relative to the object 200. The controller 20 controls the discharge of a liquid by the head 11 and the operation of the robot arm 13. With this configuration, as compared to a case where a plurality of linear motion stages are combined to move the head 11 and the detector 12, the degree of freedom of control on the movement direction and inclination of the head 11 and the detector 12 can be increased.

In the present embodiment, the movement mechanism includes the plurality of robot arms 13 that are disposed in the vicinity of the object 200, that each hold the head 11 and the detector 12, and that each move each of the head 11 and the detector 12 relative to the object 200. The controller 20 controls the discharge of the liquid by the head 11 and the operations of the plurality of robot arms 13. Since the plurality of robot arms 13 can be used to coat different regions on the object 200 simultaneously, the coating time can be reduced as compared to a case where one robot arm is used.

### Second Embodiment

A coating apparatus according to a second embodiment is described. The same name and reference sign of the above-described embodiment denote members or components identical or equivalent to those of the above-described embodiment, and the detailed description thereof is appropriately omitted.

The present embodiment differs from the first embodiment in that the controller causes the head 11 to move relative to the object 200 based on information that relates to the inclination of a roof side part with respect to a roof part of a vehicle and that is obtained from shape data D of the object 200 and three or more items of feature point information E.

### Example of Functional Configuration of Controller 20a

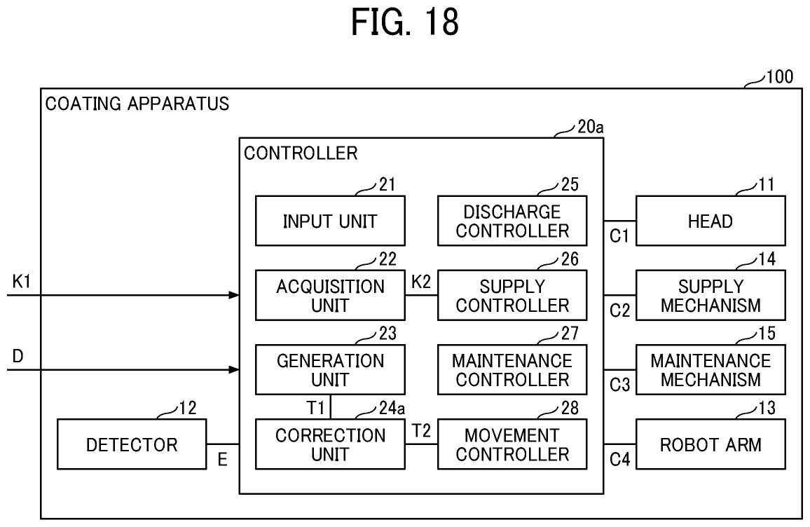

FIG. 18 is a block diagram illustrating an example of a functional configuration of a controller 20a according to the present embodiment.

The controller 20a differs from the controller 20 according to the first embodiment in that the controller 20a includes a correction unit 24a. The function of the correction unit 24a is implemented such that the CPU 31 illustrated in FIG. 2 loads a program stored in the ROM 32 into the RAM 33 and executes processing prescribed in the program.

The correction unit 24a acquires three-dimensional inclination amount information on a roof side part with respect to a roof part of an object 200 that is a vehicle from shape data D of the object 200 and three or more items of feature point information E. The three-dimensional inclination amount information on the roof side part with respect to the roof part corresponds to information relating to the inclination of the roof side part with respect to the roof part.

The correction unit 24a corrects relative movement path information T1 in accordance with the detection result of the three-dimensional inclination amount of the roof side part with respect to the roof part, and acquires corrected path information T2. The correction unit 24a outputs the acquired corrected path information T2 to the movement controller 28. The coating apparatus 100 moves the head 11 relative to the object 200 in accordance with the corrected path information T2 to three-dimensionally align the position of the object 200 and the position of the nozzle of the head 11.

### Example of Processing by Controller 20a

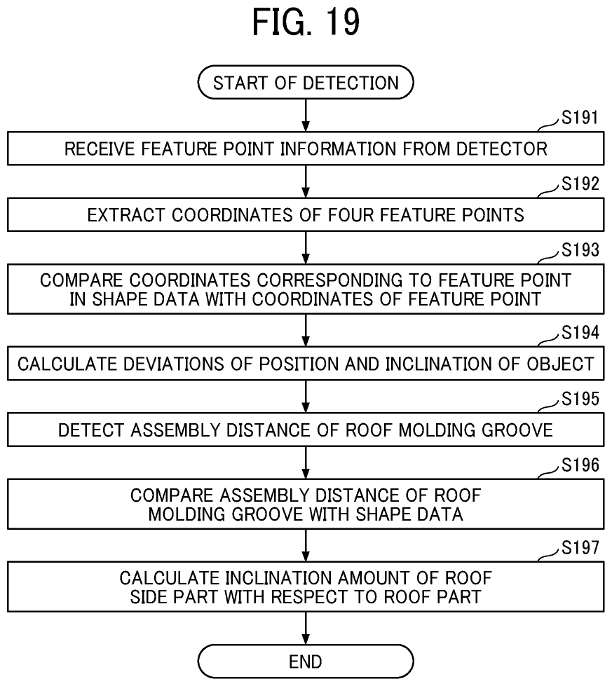

FIG. 19 is a flowchart presenting an example of detection processing for an inclination amount of a roof side part with respect to a roof part of an object 200 by the controller 20a. The correction unit 24a starts the processing in FIG. 19, for example, at the timing of performing the operation in step S75 in FIG. 7. The processing from step S191 to step S194 in FIG. 19 are the same as the processing from step S81 to step S84 in FIG. 8, and hence the redundant description is omitted here.

In step S195, the correction unit 24a detects an assembly distance of a roof molding groove in each of a front portion and a rear portion of the object 200 from three or more items of feature point information E. The roof molding groove refers to a groove formed between the roof part and the roof side part. The assembly distance refers to a width of the roof molding groove when the roof part is assembled to the roof side part. When the roof part is assembled in an inclined manner in the rotation direction with respect to predetermined shape data D of the object 200, a difference is generated between the assembly distance of the roof molding groove and the width of the roof molding groove in the shape data D.

Then, in step S196, the correction unit 24a compares the width of the roof molding groove in the shape data D of the object 200 with the assembly distance of the roof molding groove detected in step S195.

Then, in step S197, the correction unit 24a detects an inclination amount of the roof side part with respect to the roof part in accordance with the comparison result in step S196.

As described above, the correction unit 24 can detect the inclination amount of the roof side part with respect to the roof part of the object 200.

### Example of Inclination of Roof Side Part 204 with Respect to Roof Part 201

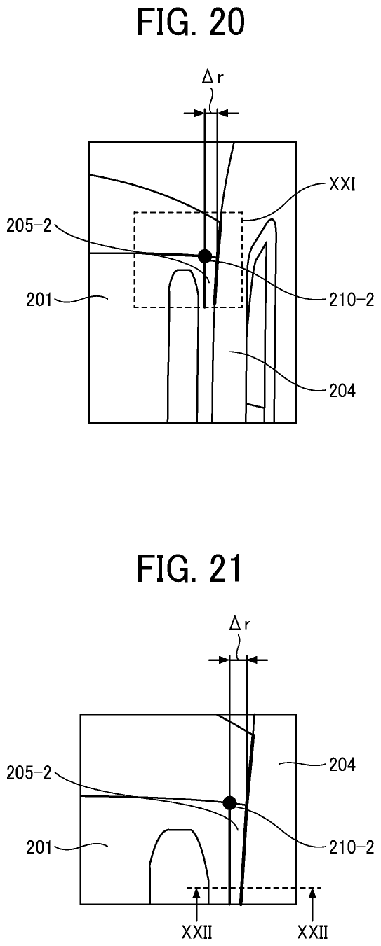

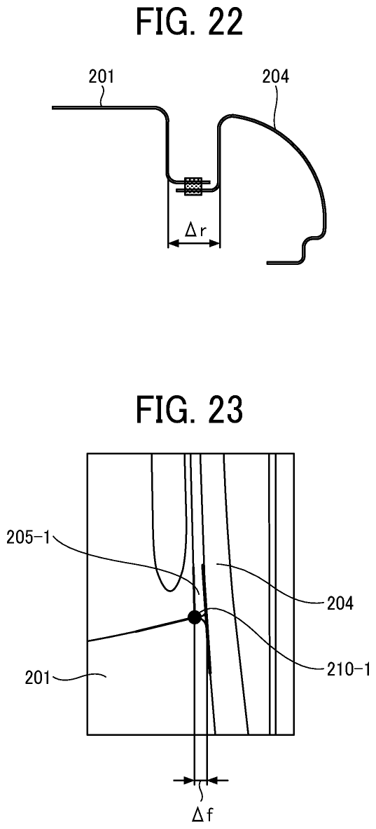

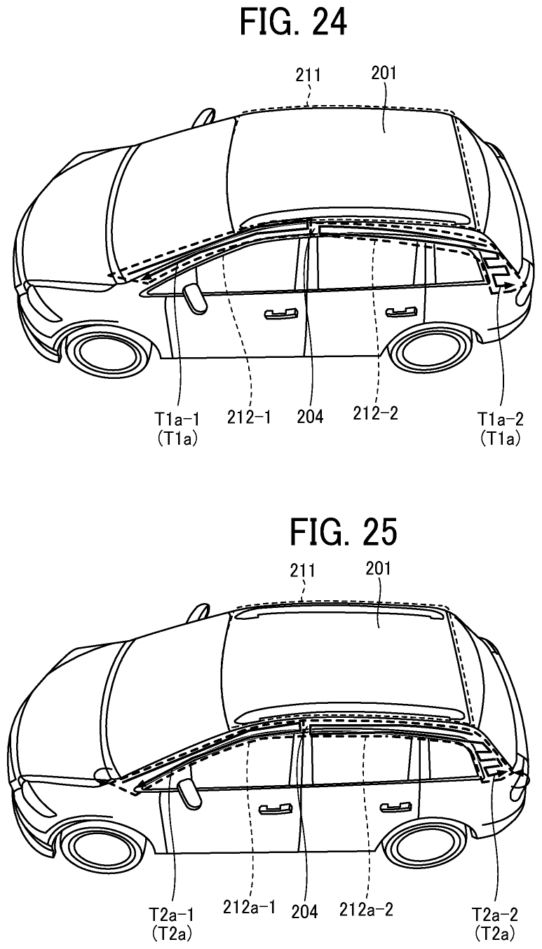

An inclination of a roof side part 204 with respect to a roof part 201 is described in detail referring to FIGS. 20 to 25. FIG. 20 is a view illustrating an example of a roof molding groove in a rear portion of the roof part 201. FIG. 21 is an enlarged view of region XXI in FIG. 20. FIG. 22 is a cross-sectional view taken along line XXII-XXII in FIG. 21. FIG. 23 is a view illustrating an example of a roof molding groove in a front portion of the roof part 201. FIG. 24 is a view illustrating an example of relative movement path information T1a on the roof side part 204. FIG. 25 is a view illustrating an example of corrected path information T2a on the roof side part 204.

FIGS. 20 to 22 illustrate the feature point 210-2 in FIG. 9 and its periphery. A roof molding groove 205-2 is a groove between the roof part 201 and the roof side part 204. A rear assembly distance Δr is an assembly distance of the roof molding groove 205-2.

In contrast, FIG. 23 illustrates the feature point 210-1 in FIG. 9 and its periphery. A roof molding groove 205-1 is a groove between the roof part 201 and the roof side part 204. A front assembly distance Δf is an assembly distance of the roof molding groove 205-1.

The correction unit 24a illustrated in FIG. 18 can calculate an inclination amount of the roof side part 204 with respect to the roof part 201 using the rear assembly distance Δr and the front assembly distance Δf.

FIG. 24 illustrates a coating range 212-1 and relative movement path information T1a-1 in the coating range 212-1, and a coating range 212-2 and relative movement path information T1a-2 in the coating range 212-2. The coating range 212-1 and the relative movement path information T1a-1, and the coating range 212-2 and the relative movement path information T1a-2 are deviated with respect to shape data D in accordance with the position and inclination of a conveyed object 200.

FIG. 25 illustrates a coating range 212a-1 and corrected path information T2a-1 in the coating range 212a-1, and a coating range 212a-2 and corrected path information T2a-2 in the coating range 212a-2. The deviations of the position and inclination of the conveyed object 200 with respect to the shape data D are corrected based on the inclination amount of the roof side part 204 with respect to the roof part 201. The coating range 212a-1 and the corrected path information T2a-1, and the coating range 212a-2 and the corrected path information T2a-2 are corrected without changes in the movement distance in the longitudinal direction or the line feed width in the transverse direction. By performing the processing in this way, the correction processing by the correction unit 24a can be simplified.

As described above, in the present embodiment, the controller 20a causes the head 11 to move relative to the object 200 based on the information that relates to the inclination of the roof side part 204 with respect to the roof part 201 of the vehicle and that is obtained from the shape data D of the object 200 and the three or more items of feature point information E. Thus, in the present embodiment, coating can be performed on the side part of the vehicle in a state in which the position of the object 200 and the position of the nozzle are three-dimensionally aligned. In other words, in the present embodiment, it is possible to provide the coating apparatus 100 that can three-dimensionally align the position of the object 200 and the position of the nozzle over the side part of the vehicle. The coating apparatus according to the present embodiment performs coating on the side part of the vehicle in the state in which the position of the object 200 and the position of the nozzle are three-dimensionally aligned, thereby performing coating with reduced coating omission or coating unevenness.

The embodiments have been described above; however, the present disclosure is not limited to the above-described embodiments. That is, various modifications and improvements can be made within the scope of the present disclosure.

In the embodiments, the liquid discharged from the head 11 may be a solution, a suspension, an emulsion, or the like, containing a solvent such as water or an organic solvent; a colorant such as a dye or a pigment; a polymerizable compound; a resin; a functional material such as a surfactant; a biocompatible material such as deoxyribonucleic acid (DNA), an amino acid or a protein, or calcium; or an edible material such as a natural colorant. The liquids can be used for, for example, applications such as inkjet inks, paints for coating, surface treatment liquids, liquids for forming resist patterns of components and electronic circuits of electronic elements and light emitting elements, and material liquids for three-dimensional shaping.

The object 200 represents a thing to which a liquid adheres and sticks, a thing to which a liquid adheres and permeates, or the like. Examples of the object 200 include recording media, such as a vehicle body, a building material, paper, recording paper, recording sheet, a film, and cloth; electronic components such as an electronic substrate and a piezoelectric element; and media such as a powder layer, an organ model, and an inspection cell, to which a liquid adheres, unless otherwise particularly limited.

Each of the functions in the above-described embodiments may be implemented by one or more processing circuits or circuitry. As used herein, the term “processing circuit or circuitry” includes a processor programmed to implement each function by software, such as a processor implemented by an electronic circuit, and devices designed to implement the functions described above, such as an application specific integrated circuit (ASIC), a digital signal processor (DSP), a field programmable gate array (FPGA), and existing circuit modules.

Aspects of the present disclosure are, for example, as follows.

In a first aspect, a coating apparatus includes a head that has a nozzle and that discharges a liquid from the nozzle to an object; a detector that outputs information relating to three-dimensional positions of three or more feature points of the object; a movement mechanism that moves the head relative to the object; and a controller that controls discharge of the liquid by the head and an operation of the movement mechanism based on predetermined shape data of the object and the information relating to the three-dimensional positions of the three or more feature points output from the detector.

According to a second aspect, in the coating apparatus of the first aspect, the controller causes the head to move relative to the object based on information that relates to a position and an inclination of the object and that is obtained from the predetermined shape data of the object and the information relating to the three-dimensional positions of the three or more feature points output from the detector.

According to a third aspect, in the coating apparatus of the first aspect or the second aspect, the nozzle includes a plurality of nozzles. The head discharges the liquid from each of the plurality of nozzles.

According to a fourth aspect, in the coating apparatus of any one of the first aspect to the third aspect, the detector includes a stereo camera.

According to a fifth aspect, in the coating apparatus of any one of the first aspect to the fourth aspect, the movement mechanism includes a robot arm that holds the head and the detector and that moves each of the head and the detector relative to the object. The controller controls the discharge of the liquid by the head and an operation of the robot arm.

According to a sixth aspect, in the coating apparatus of any one of the first aspect to the fifth aspect, the movement mechanism includes a plurality of robot arms disposed in a vicinity of the object. Each of the robot arms holds the head and the detector and moves each of the head and the detector relative to the object. The controller controls the discharge of the liquid by the head and operations of the plurality of robot arms.

According to a seventh aspect, in the coating apparatus of any one of the first aspect to the sixth aspect, the object is a vehicle including a roof part and a roof side part. The controller causes the head to move relative to the object based on information that relates to an inclination of the roof side part with respect to the roof part and that is obtained from the predetermined shape data of the object and the information relating to the three-dimensional positions of the three or more feature points output from the detector.

In an eighth aspect, an information processing apparatus includes an output unit that, in response to acquisition of predetermined shape data of an object and information relating to three-dimensional positions of three or more feature points of the object output from a detector, outputs information relating to a relative movement path with respect to the object of a head that has a nozzle and that discharges a liquid from the nozzle to the object. In a ninth aspect, a coating method uses a coating apparatus. The coating apparatus discharges, with a head having a nozzle, a liquid from the nozzle to an object; outputs, with a detector, information relating to three-dimensional positions of three or more feature points of the object; moves, with a movement mechanism, the head relative to the object; and controls, with a controller, discharge of the liquid by the head and an operation of the movement mechanism based on predetermined shape data of the object and the information relating to the three-dimensional positions of the three or more feature points output from the detector. In a tenth aspect, a program causes a coating apparatus to execute processing. The processing includes discharging, with a head having a nozzle, a liquid from the nozzle to an object; outputting, with a detector, information relating to three-dimensional positions of three or more feature points of the object; moving, with a movement mechanism, the head relative to the object; and controlling, with a controller, discharge of the liquid by the head and an operation of the movement mechanism based on predetermined shape data of the object and the information relating to the three-dimensional positions of the three or more feature points output from the detector.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

This patent application is based on and claims priority to Japanese Patent Application No. 2022-189549, filed on Nov. 28, 2022, in the Japan Patent Office, the entire disclosure of which is hereby incorporated by reference herein.

### REFERENCE SIGNS LIST

11, 11Y, 11M, 11C, 11K head
11-1, 11-2, 11-3, 11-4 head
12, 12-1, 12-2, 12-3, 12-4 detector
13, 13-1, 13-2, 13-3, 13-4 robot arm
14 supply mechanism
15 maintenance mechanism
20, 20a controller
21 input unit
22 acquisition unit
23 generation unit
24, 24a correction unit
25 discharge controller
26 supply controller
27 maintenance controller
28 movement controller
29 output unit
31 CPU
32 ROM
33 RAM
34 HDD/SSD
35 device connection I/F
36 communication I/F
100 coating apparatus
110 housing
111 supply port
112 recovery port
113 connector
200 object
201 roof part
202 front window
203 rear panel
204 roof side part
205-1, 205-2 roof molding groove
210-1, 210-2, 210-3, 210-4 feature point
210-1D, 210-2D, 210-3D, 210-4D feature point data
211, 211-1, 211-2, 211-3, 211-4 coating range
230 compressor
311 nozzle
321 nozzle plate
322 flow path
324 piezoelectric element
325 liquid
330Y, 330M, 330C, 330K liquid tank
331 pipe
332 air regulator
333 tube
340 discharge module
C1 discharge control signal
C2 supply control signal
C3 maintenance control signal
C4 movement control signal
D shape data
E feature point information
K1 object information
K2 coating color information
S system bus
P1 plane
T1, T1-1, T1-2, T1-3, T1-4 relative movement path information
T2 corrected path information
Rx, Ry, Rz inclination amount
Δf front assembly distance
Δr rear assembly distance

1. A coating apparatus comprising:
a head including a nozzle, the head to discharge a liquid from the nozzle to an object;
a detector to output information relating to three-dimensional positions of three or more feature points of the object;
a mover to move the head relative to the object; and
control circuitry configured to control discharge of the liquid by the head and an operation of the mover based on predetermined shape data of the object and the information relating to the three-dimensional positions of the three or more feature points output from the detector.

2. The coating apparatus according to claim 1, wherein:
the control circuitry causes the head to move relative to the object based on information relating to a position and an inclination of the object, obtained from the predetermined shape data of the object and the information relating to the three-dimensional positions of the three or more feature points output from the detector.

3. The coating apparatus according to claim 1, wherein:
the nozzle includes a plurality of nozzles, and the head discharges the liquid from each of the plurality of nozzles.

4. The coating apparatus according to claim 1, wherein;
the detector includes a stereo camera.

5. The coating apparatus according to claim 1, wherein:
the mover includes a robot arm holding the head and the detector and configured is to move each of the head and the detector relative to the object, and
the control circuitry controls the discharge of the liquid by the head and an operation of the robot arm.

6. The coating apparatus according to claim 1, wherein;
the mover includes a plurality of robot arms disposed in a vicinity of the object, each of the robot arms holding the head and the detector and to move each of the head and the detector relative to the object, and
the control circuitry controls the discharge of the liquid by the head and operations of the plurality of robot arms.

7. The coating apparatus according to claim 1, wherein:
the object is a vehicle including a roof part and a roof side part, and
the control circuitry causes the head to move relative to the object based on information relating to an inclination of the roof side part with respect to the roof part, obtained from the predetermined shape data of the object and the information relating to the three-dimensional positions of the three or more feature points output from the detector.

8. (canceled)

9. A coating method, comprising:
discharging a liquid from a nozzle of a head to an object;
detecting and outputting information relating to three-dimensional positions of three or more feature points of the object;
moving the head relative to the object; and
controlling the discharging of the liquid and the moving based on predetermined shape data of the object and the information relating to the three-dimensional positions of the three or more feature points detected by the detecting.

10. A non-transitory computer readable recording medium storing a program to cause a coating apparatus to execute a coating method, comprising:
discharging a liquid from a nozzle of a head to an object;
detecting and outputting information relating to three-dimensional positions of three or more feature points of the object;
moving the head relative to the object; and
controlling the discharging of the liquid and the moving based on predetermined shape data of the object and the information relating to the three-dimensional positions of the three or more feature points detected by the detecting.
